(19) United States
(12) Patent Application Publication
(10) Pub. No.: US 2026/0148916 A1
(43) Pub. Date: May 28, 2026

(54) CIRCUIT BREAKER DEVICE

(71) Applicants: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(72) Inventors: Akira DAIBO, Kokubunji Tokyo (JP); Yoshimitsu NIWA, Fuchu Tokyo (JP); Keisuke UDAGAWA, Urayasu Chiba (JP); Junichi KONDO, Kokubunji Tokyo (JP); Naoki ASARI, Fuchu Tokyo (JP)

(73) Assignees: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(21) Appl. No.: 19/454,864

(22) Filed: Jan. 21, 2026

Related U.S. Application Data
(63) Continuation of application No. PCT/JP2024/006490, filed on Feb. 22, 2024.

(30) Foreign Application Priority Data
Dec. 20, 2023 (JP) 2023-214564

(51) Int. Cl. H01H 33/666; H01H 33/59

(52) U.S. Cl. CPC H01H 33/666; H01H 33/59

(57) ABSTRACT

In a circuit breaker device in an embodiment, a first interrupting contact is connected in parallel with a current-carrying contact, and a second interrupting contact is connected in parallel with the current-carrying contact and also connected in series with the first interrupting contact. The first interrupting contact is constituted by a vacuum circuit breaker, and the second interrupting contact and the current-carrying contact are constituted by a gas circuit breaker. When executing a circuit closing operation, a second interrupting contact closing operation, and a current-carrying contact closing operation are executed. A completion time point of the first interrupting contact closing operation is at or before a completion time point of the second interrupting contact closing operation, and the completion time point of the second interrupting contact closing operation is before a completion time point of the current-carrying contact closing operation.

### CROSS REFERENCE TO RELATED APPLICATIONS

This application is a continuation of International Patent Application No. PCT/JP 2024/006490, filed on Feb. 22, 2024, which claims priority to Japanese Patent Application No. 2023-214564, filed on Dec. 20, 2023, the entire contents of each of which are incorporated herein by reference.

### FIELD Embodiments of the present invention relate to a circuit breaker device.

### BACKGROUND

In order to switch a current-carrying electric circuit from a current-carrying state to an interrupted state when an accident occurs in an electric power system, circuit breaker devices such as vacuum circuit breakers and gas circuit breakers have been used.

The vacuum circuit breaker has been configured to execute opening and closing operations with respect to a pair of contacts (electrodes) inside a vacuum vessel that is in a vacuum state. Specifically, when the vacuum circuit breaker brings the electric circuit into a current-carrying state, the distance between the contacts in a pair decreases in a vacuum atmosphere and the pair of contacts enters a closed state to establish an electrically connected state. When the vacuum circuit breaker brings the electric circuit into an interrupted state, the pair of contacts separates in a vacuum atmosphere and enters an open state to establish an electrically insulating state.

The gas circuit breaker has been configured to execute opening and closing operations with respect to a pair of contacts inside a grounded tank filled with an insulating gas. Specifically, when the gas circuit breaker brings the electric circuit into a current-carrying state, the distance between the contacts in a pair decreases in an atmosphere filled with an insulating gas and the pair of contacts enters a closed state to establish an electrically connected state. When the gas circuit breaker brings the electric circuit into an interrupted state, the pair of contacts separates in an atmosphere filled with the insulating gas and enters an open state to establish an electrically insulating state. In the gas circuit breaker, when an interrupting operation for switching from the closed state to the open state is executed, in order to extinguish the arc discharge to occur during the interrupting operation, for example, the insulating gas is blown onto the resulting arc discharge.

In the gas circuit breaker, SF₆ gas (sulfur hexafluoride gas) has been mainly used as the insulating gas to sufficiently obtain performances such as insulation performance and arc-extinguishing performance. Since having excellent performances such as insulation performance and arc-extinguishing performance, the gas circuit breaker can be suitably used for the electric circuit (such as a power transmission class electric circuit) to which a higher voltage is applied than the electric circuit interrupted by the vacuum circuit breaker.

The SF₆ gas, which has been mainly used as the insulating gas in the gas circuit breaker, has a high global warming potential. For this reason, the techniques using insulating gases other than the SF₆ gas have been proposed, but they have difficulty in obtaining sufficient performance. Specifically, when a natural origin gas such as dry air is used as the insulating gas in the gas circuit breaker in place of the SF₆ gas, the arc extinguishing capability to extinguish arc discharge is low, which may result in a decrease in interrupting performance.

For this reason, configuring the circuit breaker device by combining the gas circuit breaker and the vacuum circuit breaker has been considered. However, in the circuit breaker device configured by combining the gas circuit breaker and the vacuum circuit breaker, the following problems may occur.

Specifically, when the contacts in a pair that constitute the vacuum circuit breaker are brought into contact in order to execute a closing operation for switching the vacuum circuit breaker from the open state to the closed state and pre-arc discharge occurs between them, the metal material forming the pair of contacts is melted by the pre-arc discharge. As a result, in the vacuum circuit breaker, the contacts in a pair may be partially welded. Therefore, when an interrupting operation for switching the vacuum circuit breaker from the closed state to the open state is subsequently executed, the welded portion of the contacts in a pair constituting the vacuum circuit breaker is torn off, causing the surfaces of the contacts in a pair to become roughened. When the surfaces of the contacts become roughened in the vacuum circuit breaker, the electron multiplication factor increases, making electron avalanches more likely to occur, which may degrade the dielectric withstand capability of the vacuum circuit breaker.

Due to such circumstances as described above, in the circuit breaker device configured by combining the gas circuit breaker and the vacuum circuit breaker, it is not easy to improve the dielectric withstand capability of the entire circuit breaker device due to the decrease in the dielectric withstand capability of the vacuum circuit breaker.

Therefore, a problem to be solved by the present invention is to provide a circuit breaker device that has sufficient dielectric withstand capability even when a vacuum circuit breaker is used.

### BRIEF DESCRIPTION OF THE DRAWINGS

FIG. 1 is a circuit diagram of a circuit breaker device 100 according to a first embodiment.

FIG. 2A is a cross-sectional view schematically illustrating a configuration of the circuit breaker device 100 according to the first embodiment.

FIG. 2B is a cross-sectional view illustrating a detailed configuration of a gas circuit breaker 251 in the circuit breaker device 100 according to the first embodiment.

FIG. 3A is a circuit diagram illustrating an operation of the circuit breaker device 100 according to the first embodiment.

FIG. 3B is a circuit diagram illustrating the operation of the circuit breaker device 100 according to the first embodiment.

FIG. 3C is a circuit diagram illustrating the operation of the circuit breaker device 100 according to the first embodiment.

FIG. 4A is a cross-sectional view illustrating a state when a second interrupting contact closing operation (ST2) is executed in the gas circuit breaker 251 constituting the circuit breaker device 100 according to the first embodiment.

FIG. 4B is a cross-sectional view illustrating a state when a current-carrying contact closing operation (ST3) is executed in the gas circuit breaker 251 constituting the circuit breaker device 100 according to the first embodiment.

FIG. 5 is a view illustrating circuit closing operations (a first interrupting contact closing operation (ST1), the second interrupting contact closing operation (ST2), and the current-carrying contact closing operation (ST3)) executed in the first embodiment.

FIG. 6 is a view illustrating circuit closing operations (a first interrupting contact closing operation (ST1), a second interrupting contact closing operation (ST2), and a current-carrying contact closing operation (ST3)) executed in a modified example 1-1 in the first embodiment.

FIG. 7 is a view illustrating circuit closing operations (a first interrupting contact closing operation (ST1), a second interrupting contact closing operation (ST2), and a current-carrying contact closing operation (ST3)) executed in a second embodiment.

FIG. 8A is a cross-sectional view schematically illustrating a configuration of a circuit breaker device 100 according to a third embodiment.

FIG. 8B is a view illustrating circuit closing operations (a first interrupting contact closing operation (ST1), a second interrupting contact closing operation (ST2), and a current-carrying contact closing operation (ST3)) executed in the third embodiment.

FIG. 9 is a cross-sectional view schematically illustrating a configuration of a vacuum circuit breaker 211 including a first interrupting contact 111 in a circuit breaker device according to a fourth embodiment.

### DETAILED DESCRIPTION

A circuit breaker device in an embodiment includes: a current-carrying contact; a first interrupting contact; and a second interrupting contact. The first interrupting contact is connected in parallel with the current-carrying contact. The second interrupting contact is connected in parallel with the current-carrying contact and also connected in series with the first interrupting contact. The first interrupting contact is constituted by a vacuum circuit breaker in which a closed state and an open state are switched inside a vacuum vessel. The second interrupting contact and the current-carrying contact are constituted by a gas circuit breaker in which a closed state and an open state are switched inside an insulating gas vessel filled with an insulating gas. When executing a circuit closing operation for switching an electric circuit from an interrupted state to a current-carrying state, the circuit breaker device in the embodiment executes a first interrupting contact closing operation that switches the first interrupting contact from the open state to the closed state, a second interrupting contact closing operation that switches the second interrupting contact from the open state to the closed state, and a current-carrying contact closing operation that switches the current-carrying contact from the open state to the closed state. A completion time point of the first interrupting contact closing operation is at or before a completion time point of the second interrupting contact closing operation, and the completion time point of the second interrupting contact closing operation is before a completion time point of the current-carrying contact closing operation. When the first interrupting contact closing operation and the second interrupting contact closing operation are completed, current flows through the first interrupting contact and the second interrupting contact, and when the current-carrying contact closing operation is completed, a larger current flows through the current-carrying contact than through the first interrupting contact and the second interrupting contact.

### First Embodiment

### [A] Circuit of a Circuit Breaker Device 100

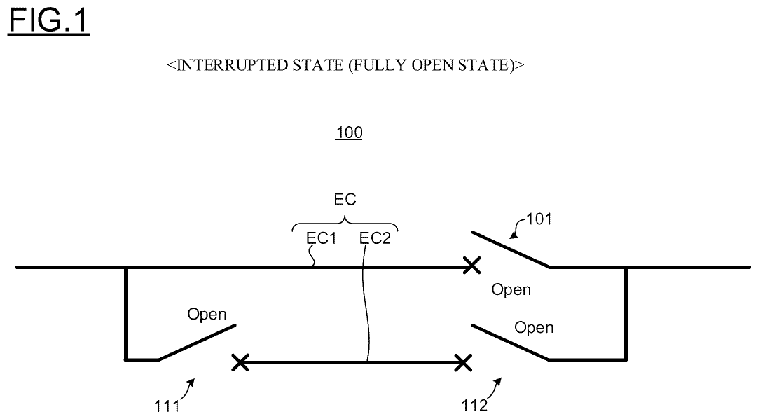

FIG. 1 is a circuit diagram of a circuit breaker device 100 according to a first embodiment.

As illustrated in FIG. 1, the circuit breaker device 100 in this embodiment is a device including a current-carrying contact 101, a first interrupting contact 111, and a second interrupting contact 112, and is installed in an electric circuit EC and configured to switch the electric circuit EC from a current-carrying state to an interrupted state. Here, the circuit breaker device 100 includes a current-carrying electric circuit EC1 and an interrupting electric circuit EC2 as the electric circuit EC, and the interrupting electric circuit EC2 is connected in parallel with the current-carrying electric circuit EC1 so as to bypass the current-carrying contact 101.

There will be explained respective parts constituting the circuit breaker device 100 in order below. Incidentally, FIG. 1 illustrates the state where the circuit breaker device 100 has switched the electric circuit EC to the interrupted state.

### [A-1] Current-Carrying Contact 101

The current-carrying contact 101 is installed in the current-carrying electric circuit EC1. The current-carrying contact 101 is configured to have a resistance smaller than that of the first interrupting contact 111 and the second interrupting contact 112. For example, the current-carrying contact 101 is configured using a conductive material that has a larger current-carrying cross-sectional area and a higher conductivity than the first interrupting contact 111 and the second interrupting contact 112.

### [A-2] First Interrupting Contact 111

The first interrupting contact 1

11 is installed in the interrupting electric circuit EC2 so as to be connected in parallel with the current-carrying contact 101.

### [A-3] Second Interrupting Contact 112

The second interrupting contact 112 is installed in the interrupting electric circuit EC2 so as to be connected in parallel with the current-carrying contact 101 and also connected in series with the first interrupting contact 111.

### [B] Detailed Configuration of the Circuit Breaker Device 100

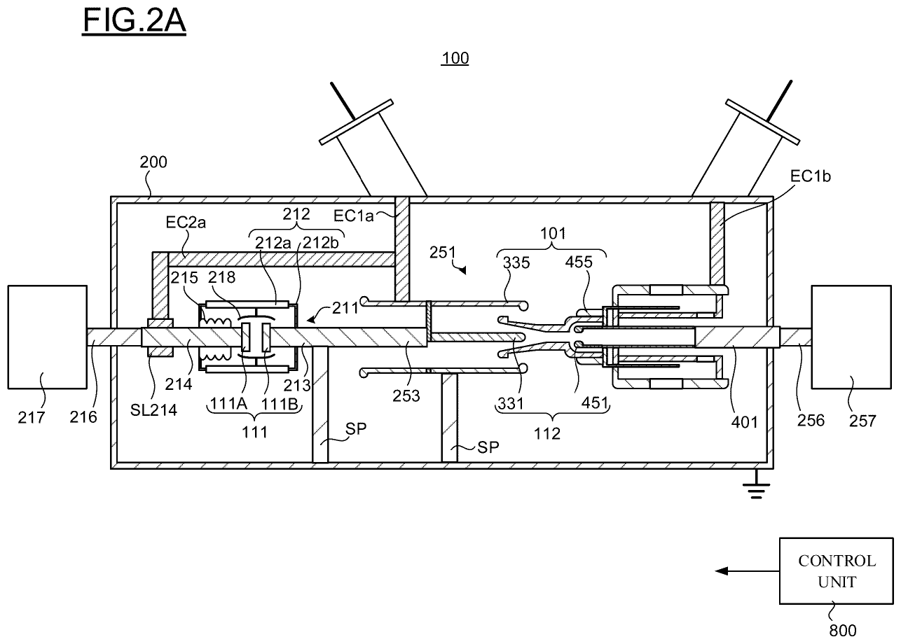

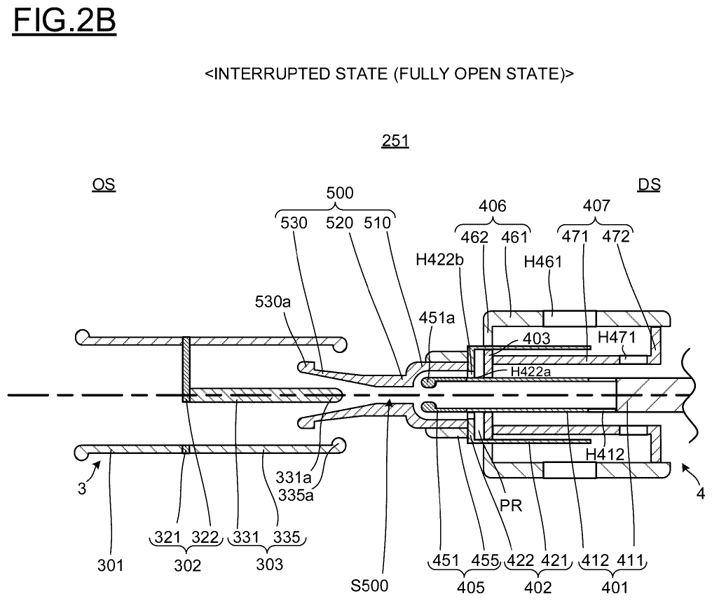

FIG. 2A is a cross-sectional view schematically illustrating the configuration of the circuit breaker device 100 according to the first embodiment. FIG. 2A illustrates the state where the circuit breaker device is in the interrupted state.

As illustrated in FIG. 2A, the circuit breaker device 100 in this embodiment houses a vacuum circuit breaker 211 and a gas circuit breaker 251 inside a grounded tank 200. Each of the parts constituting the circuit breaker device 100 will be explained in order.

### [B-1] Grounded Tank 200

The grounded tank 200 is formed of a metal material and is electrically connected to a reference potential point (such as ground). The inside of the grounded tank 200 is filled with an insulating gas.

Here, the insulating gas is, for example, a gas having a global warming potential lower than that of the SF₆ gas, but may also be the SF₆ gas. Insulating gases having a global warming potential lower than that of the SF₆ gas include, for example, gases such as carbon dioxide, oxygen, and nitrogen, and a mixed gas of the gases described above.

### [B-3] Vacuum Circuit Breaker 211 (First Interrupting Contact 111)

The vacuum circuit breaker 211 is a vacuum valve, and houses a movable electrode 111A and a fixed electrode 111B as the first interrupting contact 111 inside a vacuum vessel 212. The vacuum circuit breaker 211 is configured so that the first interrupting contact 111 switches between a closed state and an open state inside the vacuum vessel 212.

Here, the vacuum vessel 212 includes an insulating tube 212a and a pair of flanges 212b, and for example, the flanges 212b in a pair are installed at both ends of the cylindrical tubular insulating tube 212a respectively. The insulating tube 212a is formed of an insulating material (such as, ceramic), and the pair of flanges 212b is formed of, for example, a metal material. The inside of the vacuum vessel 212 is in a vacuum state, where the pressure inside the vacuum vessel 212 is lower than that inside the grounded tank 200.

The movable electrode 111A and the fixed electrode 111B are, for example, disk-shaped and formed of a metal material and are installed so as to have their ends face each other inside the vacuum vessel 212. Here, the movable electrode 111A is installed at an end of a vacuum circuit breaker movable current-carrying shaft 214. Then, the fixed electrode 111B is installed at an end of a vacuum circuit breaker fixed current-carrying shaft 213. The vacuum circuit breaker fixed current-carrying shaft 213 is installed so as to be aligned coaxially with the vacuum circuit breaker movable current-carrying shaft 214. The vacuum circuit breaker fixed current-carrying shaft 213 is supported by a support SP formed of an insulating material.

Further, the vacuum circuit breaker movable current-carrying shaft 214 is connected to an operating mechanism 217 via an insulating rod 216. The operating mechanism 217 is configured to operate the vacuum circuit breaker movable current-carrying shaft 214 using, for example, an electric spring or an electromagnetic repulsion mechanism. The vacuum circuit breaker 211 enters, by the operation of the operating mechanism 217, the closed state by establishing a contact state between the movable electrode 111A and the fixed electrode 111B, and along with this, enters the open state by establishing a separate state between the movable electrode 111A and the fixed electrode 111B.

The vacuum circuit breaker movable current-carrying shaft 214 is slidably supported by a sliding part SL214. The sliding part SL214 is formed of a metal material and is electrically connected to an electric wire EC1a via an electric wire EC2a. The electric wire EC2a constitutes the interrupting electric circuit EC2 (see FIG. 1).

A bellows 215 and an arc shield 218 are further housed inside the vacuum vessel 212.

The bellows 215 has a cylindrical tubular shape, and has the vacuum circuit breaker movable current-carrying shaft 214 passing therethrough. The internal space of the bellows 215 communicates with the internal space of the grounded tank 200. The bellows 215 is configured to expand and contract in the direction of movement when the movable electrode 111A moves with the sliding of the vacuum circuit breaker movable current-carrying shaft 214.

The arc shield 218 is installed so as to surround the movable electrode 111A and the fixed electrode 111B in the circumferential direction.

[B-3] Gas Circuit Breaker 251 (Current-Carrying Contact 101, Second Interrupting contact 112)

As illustrated in FIG. 2A, the gas circuit breaker 251 includes a gas circuit breaker movable current-carrying shaft 401 and a gas circuit breaker fixed current-carrying shaft 253. A driving-side arc contact 451 and a driving-side current-carrying contact 455 are provided on the gas circuit breaker movable current-carrying shaft 401. The gas circuit breaker fixed current-carrying shaft 253 is aligned coaxially with the gas circuit breaker movable current-carrying shaft 401, on which an opposite-side arc contact 331 and an opposite-side current-carrying contact 335 are provided. The gas circuit breaker fixed current-carrying shaft 253 is configured integrally with the vacuum circuit breaker fixed current-carrying shaft 213 and is supported by the support SP.

In the gas circuit breaker 251, the driving-side current-carrying contact 455 and the opposite-side current-carrying contact 335 function as the current-carrying contact 101. Further, in the gas circuit breaker 251, the driving-side arc contact 451 and the opposite-side arc contact 331 function as the second interrupting contact 112.

FIG. 2B is a cross-sectional view illustrating the detailed configuration of the gas circuit breaker 251 in the circuit breaker device 100 according to the first embodiment.

Hereinafter, the detailed configuration of the gas circuit breaker 251 will be explained using FIG. 2B in addition to FIG. 2A.

The gas circuit breaker 251 is a puffer type and includes an opposite-side unit 3 and a driving-side unit 4, as illustrated in FIG. 2B.

### [B-3-1] Opposite-Side Unit 3

In the gas circuit breaker 251, the opposite-side unit 3 includes a cooling cylinder 301, a support part 302, and an opposite-side contact part 303. The cooling cylinder 301, the support part 302, and the opposite-side contact part 303 are each formed of, for example, a metal material and are each electrically connected to the electric wire EC1a a (see FIG. 2A).

### [B-3-1-1] Cooling Cylinder 301

The cooling cylinder 301 is, for example, a cylindrical tubular body and is connected to the electric wire EC1a. The cooling cylinder 301 is supported by the grounded tank 200 via the support SP (see FIG. 2A).

### [B-3-1-2] Support Part 302

The support part 302 includes a support ring portion 321 and a support protrusion 322.

The support ring portion 321 is, for example, an annular ring-shaped body and is installed coaxially with the cooling cylinder 301 on the end surface of the cooling cylinder 301 located on a driving side DS. Here, the outer diameter of the support ring portion 321 is, for example, the same as that of the cooling cylinder 301, and the inner diameter of the support ring portion 321 is, for example, the same as that of the cooling cylinder 301.

The support protrusion 322 is, for example, a bar-shaped body and is provided so as to project radially inward on the inner circumferential surface of the support ring portion 321. In the support part 302, the support ring portion 321 is formed using a conductive material such as metal. In contrast, the support protrusion 322 is formed using an insulating material to establish an electrically insulating state between the opposite-side arc contact 331 and the opposite-side current-carrying contact 335 by the support protrusion 322. However, the support protrusion 322 is partially formed using a conductive material so as to electrically connect the gas circuit breaker fixed current-carrying shaft 253 and the opposite-side arc contact 331 (see FIG. 1).

### [B-3-1-3] Opposite-Side Contact Part 303

The opposite-side contact part 303 includes the opposite-side arc contact 331 and the opposite-side current-carrying contact 335, and is provided inside the grounded tank 200.

### [B-3-1-3-1] Opposite-Side Arc Contact 331

The opposite-side arc contact 331 is, for example, a cylindrical bar-shaped body and extends in the axial direction. The opposite-side arc contact 331 is installed coaxially with the cooling cylinder 301 and the like on the surface of the support protrusion 322 located on the driving side DS. An end 331a of the opposite-side arc contact 331 located on the driving side DS is curved.

### [B-3-1-3-2] Opposite-side Current-Carrying Contact 335

The opposite-side current-carrying contact 335 is, for example, a cylindrical tubular body and is installed coaxially with the opposite-side arc contact 331 and the like via the support part 302 on the end surface of the cooling cylinder 301 located on the driving side DS. The opposite-side current-carrying contact 335 includes a portion that houses the opposite-side arc contact 331 thereinside.

Here, the outer diameter of the opposite-side current-carrying contact 335 is, for example, the same as that of the cooling cylinder 301, and the inner diameter of the opposite-side current-carrying contact 335 includes a portion that is, for example, the same as the inner diameter of the cooling cylinder 301. An end 335a of the opposite-side current-carrying contact 335 located on the driving side DS projects radially inward.

### [B-3-2] Driving-Side Unit 4

The driving-side unit 4 includes the gas circuit breaker movable current-carrying shaft 401 (movable current-carrying shaft), a puffer cylinder 402, a puffer piston 403, a driving-side contact part 405, a cylinder support 406, a piston support 407, and an insulating nozzle 500. The gas circuit breaker movable current-carrying shaft 401, the puffer cylinder 402, the puffer piston 403, the driving-side contact part 405, the cylinder support 406, and the piston support 407 are each formed of, for example, a metal material and are each electrically connected to the electric wire EC1b.

### [B-3-2-1] Gas Circuit Breaker Movable Current-Carrying Shaft 401

The gas circuit breaker movable current-carrying shaft 401 is a bar-shaped body and is installed coaxially with the opposite-side arc contact 331 and the like. The gas circuit breaker movable current-carrying shaft 401 is connected to an operating mechanism 257 via an insulating rod 256. The operating mechanism 257 is configured to operate the gas circuit breaker movable current-carrying shaft 401 using, for example, an electric spring or an electromagnetic repulsion mechanism, and the gas circuit breaker movable current-carrying shaft 401 moves in the axial direction by the operating mechanism 257.

Here, the gas circuit breaker movable current-carrying shaft 401 includes a movable current-carrying shaft solid portion 411 and a movable current-carrying shaft hollow portion 412.

The movable current-carrying shaft solid portion 411 has, for example, a cylindrical shape.

The movable current-carrying shaft hollow portion 412 has, for example, a cylindrical tubular shape, and has an end thereof that is located on the driving side DS connected to the movable current-carrying shaft solid portion 411. The outer diameter of the movable current-carrying shaft hollow portion 412 is, for example, the same as that of the movable current-carrying shaft solid portion 411. The inner diameter of the movable current-carrying shaft hollow portion 412 is larger than the outer diameter of the opposite-side arc contact 331. A first ventilation hole H412, which passes through in the radial direction, is formed in the end of the movable current-carrying shaft hollow portion 412 located on the driving side DS.

### [B-3-2-2] Puffer Cylinder 402

The puffer cylinder 402 is configured to slide in the axial direction together with the gas circuit breaker movable current-carrying shaft 401 by the operating mechanism 257.

Here, the puffer cylinder 402 includes a cylinder cylindrical tubular portion 421 and a cylinder bottom plate portion 422.

The cylinder cylindrical tubular portion 421 is, for example, a cylindrical tubular body and is installed coaxially with the opposite-side arc contact 331 and the like. The inner diameter of the cylinder cylindrical tubular portion 421 is larger than the outer diameter of the gas circuit breaker movable current-carrying shaft 401, and the gas circuit breaker movable current-carrying shaft 401 is housed inside the cylinder cylindrical tubular portion 421.

The cylinder bottom plate portion 422 is, for example, a disk-shaped plate body and is provided at the end of the cylinder cylindrical tubular portion 421 located on the driving side DS.

A rod through hole H422a through which the gas circuit breaker movable current-carrying shaft 401 passes is formed in the center of the cylinder bottom plate portion 422. The inner diameter of the rod through hole H422a is substantially the same as the outer diameter of the gas circuit breaker movable current-carrying shaft 401, and the gas circuit breaker movable current-carrying shaft 401 is fixed to the puffer cylinder 402 with the gas circuit breaker movable current-carrying shaft 401 passing through the rod through hole H422a. The cylinder bottom plate portion 422 and the gas circuit breaker movable current-carrying shaft 401 are electrically connected.

Further, an exhaust hole H422b is formed in the cylinder bottom plate portion 422. The exhaust hole H422b is formed so as to pass through in the axial direction around the rod through hole H422a. Here, the exhaust hole H422b is configured to communicate with the rod through hole H422a, for example.

### [B-3-2-3] Puffer Piston 403

The puffer piston 403 is housed inside the puffer cylinder 402. The puffer piston 403 is fixed to the grounded tank 200 via the cylinder support 406 and the piston support 407. The puffer piston 403 is, for example, an annular ring-shaped body and is installed coaxially with the opposite-side arc contact 331 and the like. The gas circuit breaker movable current-carrying shaft 401 passes through the inside of the puffer piston 403.

Here, the inner diameter of the puffer piston 403 is substantially the same as the outer diameter of the gas circuit breaker movable current-carrying shaft 401, and the gas circuit breaker movable current-carrying shaft 401 is slidable in the axial direction relative to the puffer piston 403. Further, the outer diameter of the puffer piston 403 is substantially the same as the inner diameter of the cylinder cylindrical tubular portion 421 constituting the puffer cylinder 402, and the puffer cylinder 402 is slidable in the axial direction relative to the puffer piston 403.

The puffer piston 403 partitions the inside of the puffer cylinder 402 in the axial direction. The space inside the puffer cylinder 402 located on the driving side DS relative to the puffer piston 403 is a puffer chamber PR. The volume of the puffer chamber PR varies as the puffer cylinder 402 moves in the axial direction together with the gas circuit breaker movable current-carrying shaft 401. As the volume of the puffer chamber PR decreases, the pressure of the insulating gas increases inside the puffer chamber PR. Then, the insulating gas whose pressure has increased in the puffer chamber PR is discharged from the puffer chamber PR through the exhaust hole H422b of the puffer cylinder 402.

### [B-3-2-4] Driving-Side Contact Part 405

The driving-side contact part 405 is configured to slide in the axial direction together with the gas circuit breaker movable current-carrying shaft 401 by the operating mechanism 257, thereby varying the distance between the driving-side contact part 405 and the opposite-side contact part 303.

Here, the driving-side contact part 405 includes the driving-side arc contact 451 and the driving-side current-carrying contact 455.

### [B-3-2-4-1] Driving-Side Arc Contact 451

The driving-side arc contact 451 is, for example, a cylindrical tubular body and is installed coaxially with the opposite-side arc contact 331 and the like.

Here, the driving-side arc contact 451 has substantially the same outer diameter and inner diameter as the movable current-carrying shaft hollow portion 412 constituting the gas circuit breaker movable current-carrying shaft 401. The driving-side arc contact 451 is connected to the end of the movable current-carrying shaft hollow portion 412 located on an opposite side OS and is electrically connected to the gas circuit breaker movable current-carrying shaft 401. The driving-side arc contact 451 is configured to slide in the axial direction together with the gas circuit breaker movable current-carrying shaft 401 by the operating mechanism 257.

An end 451a of the driving-side arc contact 451 located on the opposite side OS projects radially inward, and the inner diameter of the end 451a is the same as the outer diameter of the opposite-side arc contact 331.

The driving-side arc contact 451 is configured so that the opposite-side arc contact 331 is inserted thereinside in the current-carrying state, and arc discharge occurs between the driving-side arc contact 451 and the opposite-side arc contact 331 during the interrupting process.

### [B-3-2-4-2] Driving-Side Current-Carrying Contact 455

The driving-side current-carrying contact 455 is, for example, an annular ring-shaped body and is installed coaxially with the opposite-side arc contact 331 and the like. The driving-side current-carrying contact 455 includes a portion that houses the driving-side arc contact 451 thereinside.

Here, the inner diameter of the driving-side current-carrying contact 455 is larger than the outer diameter of the driving-side arc contact 451. The outer diameter of the driving-side current-carrying contact 455 is the same as the inner diameter of the end 335a of the opposite-side current-carrying contact 335. The driving-side current-carrying contact 455 is fixed to the cylinder bottom plate portion 422 of the puffer cylinder 402 so as to surround the driving-side arc contact 451 and is electrically connected to the puffer cylinder 402. The driving-side current-carrying contact 455 is configured to slide in the axial direction together with the gas circuit breaker movable current-carrying shaft 401 by the operating mechanism 257.

An end 455a of the driving-side current-carrying contact 455 located on the opposite side OS is, for example, curved.

The driving-side current-carrying contact 455 is configured to be inserted inside the opposite-side current-carrying contact 335 in the current-carrying state.

### [B-3-2-5] Cylinder Support 406

The cylinder support 406 is electrically connected to the puffer cylinder 402 and the electric wire EC1b. The cylinder support 406 is fixed to the grounded tank 200 and supports the puffer cylinder 402 so that the puffer cylinder 402 slides in the axial direction.

Here, the cylinder support 406 includes a cylinder support cylindrical tubular portion 461 and a cylinder support ring portion 462.

The cylinder support cylindrical tubular portion 461 is a cylindrical tubular body and is installed coaxially with the opposite-side arc contact 331 and the like. The inner diameter of the cylinder support cylindrical tubular portion 461 is larger than the outer diameter of the cylinder cylindrical tubular portion 421 constituting the puffer cylinder 402.

The cylinder support ring portion 462 is an annular ring-shaped body and is installed coaxially with the opposite-side arc contact 331 and the like. The cylinder support ring portion 462 is provided at the end of the cylinder support cylindrical tubular portion 461 located on the opposite side OS and is configured to project radially inward from the cylinder support cylindrical tubular portion 461. Here, the cylinder support ring portion 462 is formed integrally with the cylinder support cylindrical tubular portion 461. The inner diameter of the cylinder support ring portion 462 is the same as the outer diameter of the cylinder support cylindrical tubular portion 421 constituting the puffer cylinder 402.

A second ventilation hole H461 is formed in the cylinder support cylindrical tubular portion 461. The second ventilation hole H461 is configured to pass through the cylinder support cylindrical tubular portion 461 in the radial direction.

### [B-3-2-6] Piston Support 407

The piston support 407 is fixed to the cylinder support 406 and supports the puffer piston 403. The gas circuit breaker movable current-carrying shaft 401 passes through the inside of the piston support 407.

Here, the piston support 407 includes a piston support cylindrical tubular portion 471 and a piston support ring portion 472.

The piston support cylindrical tubular portion 471 is a cylindrical tubular body and is installed coaxially with the opposite-side arc contact 331 and the like. The outer diameter of the piston support cylindrical tubular portion 471 is smaller than that of the puffer piston 403, and the inner diameter of the piston support cylindrical tubular portion 471 is larger than the outer diameter of the gas circuit breaker movable current-carrying shaft 401. The end of the piston support cylindrical tubular portion 471 located on the opposite side OS is connected to the puffer piston 403.

The piston support ring portion 472 is an annular ring-shaped body and is installed coaxially with the opposite-side arc contact 331 and the like. The piston support ring portion 472 is provided at the end of the piston support cylindrical tubular portion 471 located on the driving side DS. The outer diameter of the piston support ring portion 472 is smaller than that of the piston support cylindrical tubular portion 471, and the inner diameter of the piston support ring portion 472 is larger than the outer diameter of the gas circuit breaker movable current-carrying shaft 401. The outer diameter of the piston support ring portion 472 is the same as the inner diameter of the cylinder support cylindrical tubular portion 461, and the piston support ring portion 472 is fixed to the cylinder support cylindrical tubular portion 461. Here, the piston support ring portion 472 is formed integrally with the cylinder support cylindrical tubular portion 471.

A third ventilation hole H471 is formed in the piston support cylindrical tubular portion 471. The third ventilation hole H471 is configured to pass through the piston support cylindrical tubular portion 471 in the radial direction.

### [B-3-2-7] Insulating Nozzle 500

The insulating nozzle 500 is formed of an insulating material. The insulating nozzle 500 is a cylindrical tubular body and is installed coaxially with the opposite-side arc contact 331 and the like inside the grounded tank 200.

The insulating nozzle 500 is fixed to the puffer cylinder 402 and is configured to move together with the puffer cylinder 402, the driving-side contact part 405, and the like, during the interrupting process of transitioning from the current-carrying state (closed state) to the open state (open state).

A nozzle internal space S500 is formed inside the insulating nozzle 500, and the opposite-side arc contact 331 and the driving-side arc contact 451 are housed in the nozzle internal space S500. Further, the insulating nozzle 500 is configured so that the insulating gas is discharged from the puffer chamber PR into the nozzle internal space S500 when arc discharge occurs between the opposite-side contact part 303 and the driving-side contact part 405 during the interrupting process.

The insulating nozzle 500 includes a nozzle large diameter portion 510, a nozzle small diameter portion 520, and a nozzle inclined portion 530.

The nozzle large diameter portion 510 is a portion of the insulating nozzle 500 located on the driving side DS and is interposed between the driving-side arc contact 451 and the driving-side current-carrying contact 455. The nozzle large diameter portion 510 includes a portion whose outer circumferential surface extends along the axial direction.

The nozzle small diameter portion 520 is located on the opposite side OS relative to the nozzle large diameter portion 510 in the insulating nozzle 500. The nozzle small diameter portion 520 includes a portion whose outer circumferential surface extends along the axial direction. The outer diameter of the portion whose outer circumferential surface extends along the axial direction in the nozzle small diameter portion 520 is smaller than that of the nozzle large diameter portion 510.

The nozzle inclined portion 530 is located on the opposite side OS relative to the nozzle small diameter portion 520 in the insulating nozzle 500. The nozzle inclined portion 530 includes a portion whose outer circumferential surface is inclined relative to the axial direction, such that the outer diameter increases as it moves from the nozzle small diameter portion 520 toward the opposite side OS. An end 530a of the nozzle inclined portion 530 located on the opposite side OS projects radially outward, and the outer diameter of the end 530a is smaller than the inner diameter of the opposite-side current-carrying contact 335.

### [B-4] Control Unit 800

As illustrated in FIG. 2A, the circuit breaker device 100 includes a control unit 800 in addition to the above.

The control unit 800 includes an arithmetic unit (not illustrated) and a memory device (not illustrated), and is configured to control the operation of each part constituting the circuit breaker device 100, for example, by a high-speed sequence, by the arithmetic unit performing arithmetic processing using a program stored in the memory device.

The control unit 800 outputs control signals to the operating mechanism 217 and the operating mechanism 257 based on, for example, a command input from the outside, and controls the operations of the operating mechanism 217 and the operating mechanism 257. Thereby, the control unit 800 executes a circuit interrupting operation for switching the electric circuit EC from the current-carrying state to the interrupted state, and a circuit closing operation for switching the electric circuit EC from the interrupted state to the current-carrying state.

When executing the circuit interrupting operation, the control unit 800 controls the operations of the operating mechanism 217 and the operating mechanism 257 so as to switch each of the current-carrying contact 101, the first interrupting contact 111, and the second interrupting contact 112 from the closed state to the open state. When executing the circuit closing operation, the control unit 800 controls the operations of the operating mechanism 217 and the operating mechanism 257 so as to switch each of the current-carrying contact 101, the first interrupting contact 111, and the second interrupting contact 112 from the open state to the closed state.

### [C] Operation of the Circuit Breaker Device 100

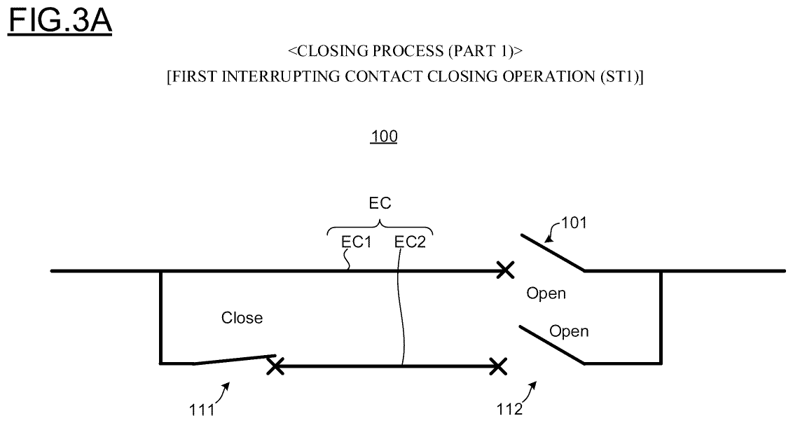

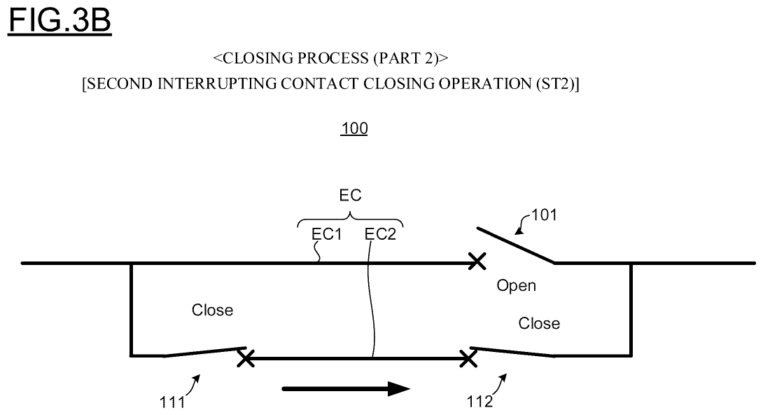

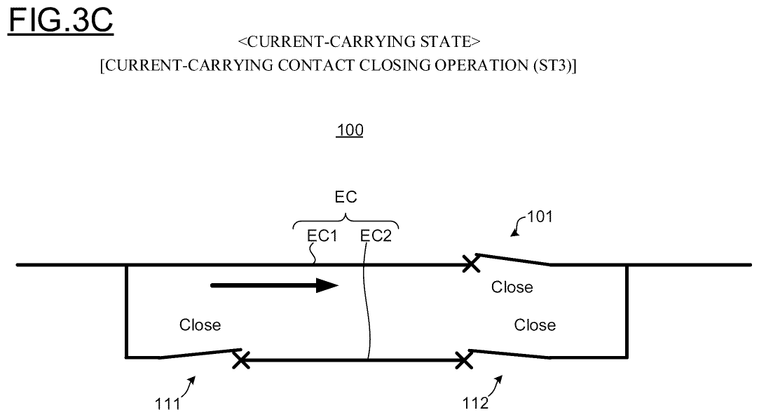

FIG. 3A, FIG. 3B, and FIG. 3C are circuit diagrams illustrating the operation of the circuit breaker device 100 according to the first embodiment.

FIG. 3A, FIG. 3B, and FIG. 3C, together with FIG. 1, illustrate the state when the circuit closing operation is executed in the circuit breaker device 100. In each of the drawings, a state where each contact is in an electrically insulating state is illustrated as an open state (“Open” in the drawing), and a state where each contact is in an electrically connected state is illustrated as a closed state (“Close” in the drawing).

When the circuit closing operation is executed in the circuit breaker device 100 in this embodiment, the electric circuit EC undergoes a closing process sequentially illustrated in FIG. 3A, FIG. 3B, and FIG. 3C from the interrupted state (fully open state) illustrated in FIG. 1 to enter the current-carrying state, and current flows through the electric circuit EC. That is, in the circuit closing operation, as illustrated in FIG. 3A, FIG. 3B, and FIG. 3C, a first interrupting contact closing operation (ST1), a second interrupting contact closing operation (ST2), and a current-carrying contact closing operation (ST3) are sequentially executed.

Details of the circuit closing operation will be explained below.

### [C-1] Interrupted State

In the interrupted state before executing the circuit closing operation, as illustrated in FIG. 1, the first interrupting contact 111, the second interrupting contact 112, and the current-carrying contact 101 are in the open state.

Specifically, in the vacuum circuit breaker 211, the movable electrode 111A and the fixed electrode 111B, which are housed as the first interrupting contact 111 inside the vacuum vessel 212, separate to enter an electrically insulating state, and thereby the first interrupting contact 111 is in the open state. Further, in the gas circuit breaker 251, the driving-side current-carrying contact 455 and the opposite-side current-carrying contact 335, which constitute the current-carrying contact 101, separate to enter an electrically insulating state, and thereby the current-carrying contact 101 is in the open state. Further, in the gas circuit breaker 251, the driving-side arc contact 451 and the opposite-side arc contact 331, which constitute the second interrupting contact 112, separate to enter an electrically insulating state, and thereby the second interrupting contact 112 is in the open state (see FIG. 2A).

Thereby, in the interrupted state, current is interrupted in each of the current-carrying electric circuit EC1 and the interrupting electric circuit EC2 of the electric circuit EC (see FIG. 1). Incidentally, in the gas circuit breaker 251, the current-carrying contact 101 and the second interrupting contact 112 have dielectric withstand capability capable of withstanding an operating voltage before executing the circuit closing operation.

### [C-2] Closing Process

### [C-2-1] First Interrupting Contact Closing Operation (ST1)

In the circuit closing operation, as illustrated in FIG. 3A, first, the first interrupting contact closing operation (ST1) is executed. In the first interrupting contact closing operation (ST1), the first interrupting contact 111 switches from the open state to the closed state.

Although not illustrated, in the first interrupting contact closing operation (ST1), in the vacuum circuit breaker 211, the distance between the movable electrode 111A and the fixed electrode 111B, which are housed as the first interrupting contact 111 inside the vacuum vessel 212, decreases and an electrically connected state is established (see FIG. 2A). Incidentally, in the gas circuit breaker 251, the current-carrying contact 101 and the second interrupting contact 112 have the dielectric withstand capability capable of withstanding the operating voltage even after the first interrupting contact closing operation (ST1) is completed.

### [C-2-2] Second Interrupting Contact Closing Operation (ST2)

Next, in the circuit closing operation, as illustrated in FIG. 3B, the second interrupting contact closing operation (ST2) is executed. In the second interrupting contact closing operation (ST2), the second interrupting contact 112 switches from the open state to the closed state.

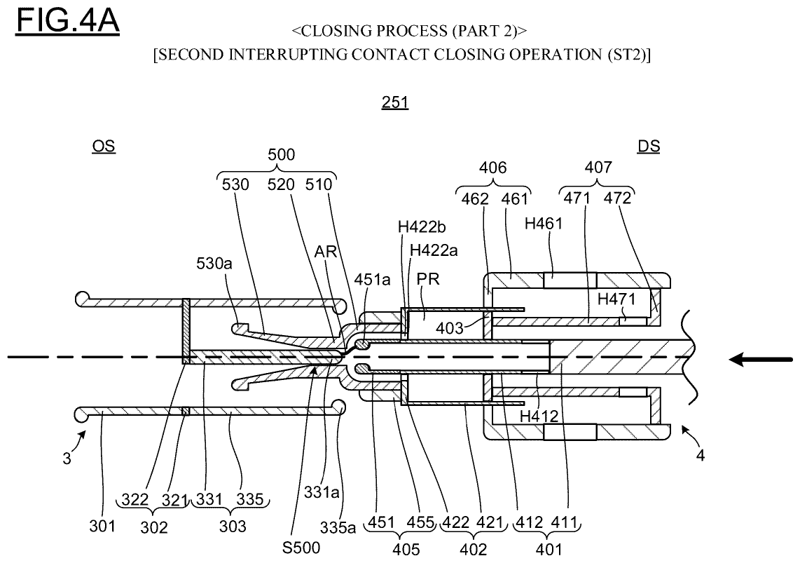

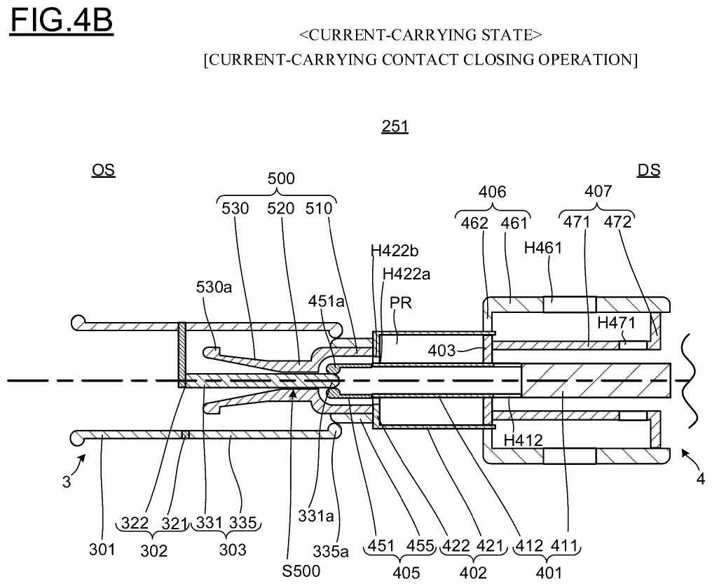

FIG. 4A is a cross-sectional view illustrating a state when the second interrupting contact closing operation (ST2) is executed in the gas circuit breaker 251 constituting the circuit breaker device 100 according to the first embodiment.

As illustrated in FIG. 4A, in the second interrupting contact closing operation (ST2), in the gas circuit breaker 251, the distance between the driving-side arc contact 451 and the opposite-side arc contact 331, which constitute the second interrupting contact 112, decreases and an electrically connected state is established.

Specifically, when the second interrupting contact closing operation (ST2) is executed, in the gas circuit breaker 251, the gas circuit breaker movable current-carrying shaft 401 moves from the driving side DS to the opposite side OS, and thereby the driving-side arc contact 451 approaches the opposite-side arc contact 331. At this time, pre-arc discharge AR occurs between the opposite-side arc contact 331 and the driving-side arc contact 451 inside the insulating nozzle 500. Due to the pre-arc discharge AR, the electrically connected state is established between the opposite-side arc contact 331 and the driving-side arc contact 451.

Upon the completion of the first interrupting contact closing operation (ST1) and the second interrupting contact closing operation (ST2), the first interrupting contact 111 enters the closed state and the second interrupting contact 112 enters the closed state, and thereby, current flows through the interrupting electric circuit EC2 where the first interrupting contact 111 and the second interrupting contact 112 are installed (see FIG. 3B).

### [C-2-3] Current-Carrying Contact Closing Operation (ST3)

Next, in the circuit closing operation, as illustrated in FIG. 3C, the current-carrying contact closing operation (ST3) is executed. In the current-carrying contact closing operation (ST3), the current-carrying contact 101 switches from the open state to the closed state.

FIG. 4B is a cross-sectional view illustrating a state when the current-carrying contact closing operation (ST3) is executed in the gas circuit breaker 251 constituting the circuit breaker device 100 according to the first embodiment.

As illustrated in FIG. 4B, in the current-carrying contact closing operation (ST3), in the gas circuit breaker 251, the distance between the driving-side current-carrying contact 455 and the opposite-side current-carrying contact 335, which constitute the current-carrying contact 101, decreases and an electrically connected state is established, and thereby the current-carrying contact 101 switches to the closed state.

Specifically, when the current-carrying contact closing operation (ST3) is executed, in the gas circuit breaker 251, the gas circuit breaker movable current-carrying shaft 401 further moves from the driving side DS to the opposite side OS, and thereby the driving-side arc contact 451 comes into contact with the opposite-side arc contact 331, and then the opposite-side current-carrying contact 335 and the driving-side current-carrying contact 455 come closer together. Then, as the gas circuit breaker movable current-carrying shaft 401 further moves from the driving side DS to the opposite side OS, the opposite-side current-carrying contact 335 and the driving-side current-carrying contact 455 make contact and enter an electrically connected state.

Thus, in the circuit breaker device 100 in this embodiment, the current-carrying contact 101, the first interrupting contact 111, and the second interrupting contact 112 switch to the closed state, and thereby the electric circuit EC switches to the current-carrying state. As described above, in this embodiment, the current-carrying contact 101 is configured to have a resistance smaller than that of the first interrupting contact 111 and the second interrupting contact 112. For this reason, after the current-carrying contact closing operation (ST3) is completed, a larger current flows through the current-carrying electric circuit EC1, where the current-carrying contact 101 is installed, than through the interrupting electric circuit EC2, where the first interrupting contact 111 and the second interrupting contact 112 are installed. That is, commutation occurs (see FIG. 3C).

### [D] Details of the Circuit Closing Operation

The circuit closing operation executed in this embodiment will be explained in more detail.

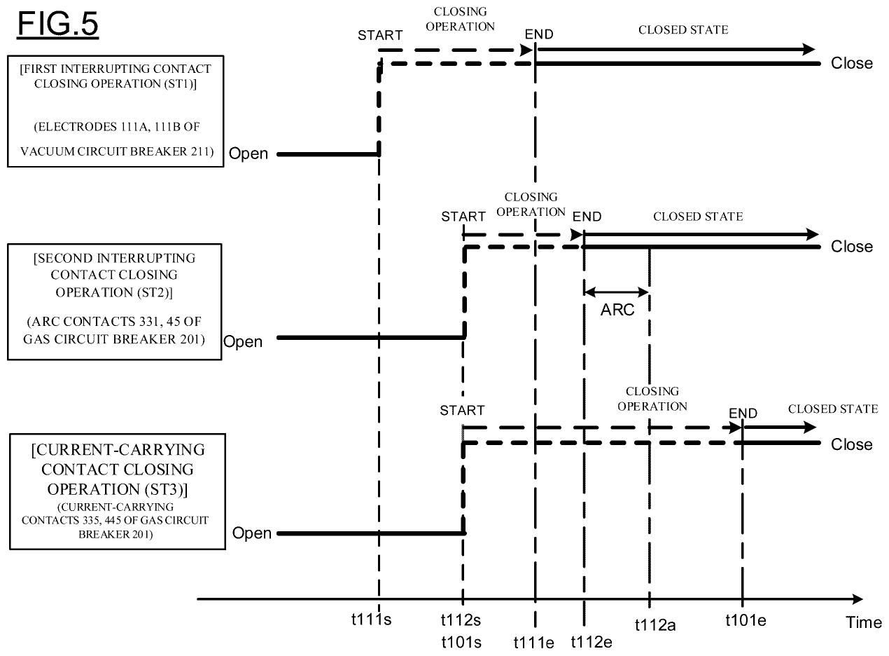

FIG. 5 is a view illustrating the circuit closing operations (the first interrupting contact closing operation (ST1), the second interrupting contact closing operation (ST2), and the current-carrying contact closing operation (ST3)) executed in the first embodiment.

In FIG. 5, the horizontal axis represents time, and the vertical axis indicates a state of each contact (the current-carrying contact 101, the first interrupting contact 111, and the second interrupting contact 112). In FIG. 5, the state where each contact is in the open state (electrically insulating state) is indicated as “Open,” and the state where each contact is in the closed state (electrically connected state) is indicated as “Close” (the broken line portion indicates transition from the open state to the closed state). Further, in FIG. 5, the time point at which the closing operation is started at each contact (the time point at which the distance between the pair of contacts (electrodes) begins to decrease) is indicated as “START,” the time point at which the closing operation is completed at each contact (the time point at which the state between the pair of contacts (electrodes) switches to the electrically connected state) is indicated as “END,” and the period during which pre-arc discharge occurs is indicated as “ARC.”

As illustrated in FIG. 5, the first interrupting contact closing operation (ST1) is started at a start time point t111s and completed at a completion time point t111e, and the first interrupting contact 111 switches from the open state to the closed state. The second interrupting contact closing operation (ST2) is started at a start time point t112s and completed at a completion time point t112e, and the second interrupting contact 112 switches from the open state to the closed state. The current-carrying contact closing operation (ST3) is started at a start time point t101s and completed at a completion time point t101e, and the current-carrying contact 101 switches from the open state to the closed state. Incidentally, the completion time point t112e of the second interrupting contact closing operation (ST2) is the time point at which pre-arc discharge AR occurs between the opposite-side arc contact 331 and the driving-side arc contact 451 constituting the second interrupting contact 112, and the electrically connected state is established therebetween. After the completion time point t112e of the second interrupting contact closing operation (ST2), by an arc extinction time point t112a at which the pre-arc discharge AR is extinguished, the opposite-side arc contact 331 and the driving-side arc contact 451 constituting the second interrupting contact 112 are physically connected, and the electrically connected state therebetween is maintained (see FIG. 4A).

In this embodiment, the start time point t111s of the first interrupting contact closing operation (ST1) is at or before the start time point t112s of the second interrupting contact closing operation (ST2). Here, the start time point t111s of the first interrupting contact closing operation (ST1) is before the start time point t112s of the second interrupting contact closing operation (ST2). Further, the completion time point t111e of the first interrupting contact closing operation (ST1) is at or before the completion time point t112e of the second interrupting contact closing operation (ST2). Here, the completion time point t111e of the first interrupting contact closing operation (ST1) is after the start time point t112s of the second interrupting contact closing operation (ST2) and before the completion time point t112e of the second interrupting contact closing operation (ST2).

In this embodiment, the start time point t112s of the second interrupting contact closing operation (ST2) is before the completion time point t111e of the first interrupting contact closing operation (ST1). The completion time point t112e of the second interrupting contact closing operation (ST2) is before the completion time point t101e of the current-carrying contact closing operation (ST3).

In this embodiment, the start time point t101s of the current-carrying contact closing operation (ST3) is the same as the start time point t112s of the second interrupting contact closing operation (ST2). Here, the start time point t101s of the current-carrying contact closing operation (ST3) is after the completion time point t111e of the first interrupting contact closing operation (ST1) and before the completion time point t112e of the second interrupting contact closing operation (ST2). The completion time point t101e of the current-carrying contact closing operation (ST3) is after the arc extinction time point t112a at which the pre-arc discharge AR is extinguished in the second interrupting contact 112. Incidentally, the start time point t101s of the current-carrying contact closing operation (ST3) does not have to be the same as the start time point t112s of the second interrupting contact closing operation (ST2). That is, the gas circuit breaker 251 may be configured so that the driving-side arc contact 451 and the driving-side current-carrying contact 455 move independently of each other.

### [E] Summary

As described above, the circuit breaker device 100 in this embodiment includes the current-carrying contact 101, the first interrupting contact 111, and the second interrupting contact 112. The first interrupting contact 111 is connected in parallel with the current-carrying contact 101, and the second interrupting contact 112 is connected in parallel with the current-carrying contact 101, and also connected in series with the first interrupting contact 111. The first interrupting contact 111 is constituted by the vacuum circuit breaker 211 in which the closed state and the open state are switched inside the vacuum vessel 212. The second interrupting contact 112 and the current-carrying contact 101 are constituted by the gas circuit breaker 251 in which the closed state and the open state are switched inside an insulating gas vessel 202 filled with the insulating gas.

In the circuit breaker device 100 in this embodiment, since the current-carrying contact 101 is constituted by the gas circuit breaker 251, sufficient current-carrying performance can be obtained in the current-carrying state. For this reason, in the circuit breaker device 100 in this embodiment, the vacuum circuit breaker 211 constituting the first interrupting contact 111 does not need to improve the current-carrying performance, which makes it possible to switch from the closed state to the open state at a higher speed, and obtain sufficient dielectric withstand capability. Further, in the circuit breaker device 100 in this embodiment, the first interrupting contact 111 constituted by the vacuum circuit breaker 211 is used to achieve the interrupted state finally. Therefore, in the gas circuit breaker 251 constituting the current-carrying contact 101 and the second interrupting contact 112, it is possible to achieve a reduction in the amount of SF₆ gas used, which has high performances such as insulation performance and arc-extinguishing performance, and also to apply a gas having a global warming potential lower than that of the SF₆ gas as the insulating gas.

As described above, in this embodiment, when executing the circuit closing operation, the first interrupting contact closing operation (ST1) for switching the first interrupting contact 111 from the open state to the closed state, the second interrupting contact closing operation (ST2) for switching the second interrupting contact 112 from the open state to the closed state, and the current-carrying contact closing operation (ST3) for switching the current-carrying contact 101 from the open state to the closed state are executed.

In this embodiment, the completion time point t111e of the first interrupting contact closing operation (ST1) is before the completion time point t112e of the second interrupting contact closing operation (ST2). Then, the completion time point t112e of the second interrupting contact closing operation (ST2) is before the completion time point t101e of the current-carrying contact closing operation (ST3) (see FIG. 5).

Thus, in the first interrupting contact closing operation (ST1) in this embodiment, the first interrupting contact 111 switches from the open state to the closed state when the second interrupting contact 112 is in the open state. That is, in the vacuum circuit breaker 211, when the distance between the movable electrode 111A and the fixed electrode 111B, which constitute the first interrupting contact 111, decreases and they transition to the electrically connected state, the electrically insulating state is maintained between the opposite-side arc contact 331 and the driving-side arc contact 451 that constitute the second interrupting contact 112 (see FIG. 2A and FIG. 3A). Therefore, since current does not flow through the interrupting electric circuit EC2 in the first interrupting contact closing operation (ST1), pre-arc discharge does not occur between the movable electrode 111A and the fixed electrode 111B even when the distance between the movable electrode 111A and the fixed electrode 111B, which constitute the vacuum circuit breaker 211, decreases. Therefore, in this embodiment, even if contact is made between the movable electrode 111A and the fixed electrode 111B that constitute the vacuum circuit breaker 211 after the completion of the first interrupting contact closing operation (ST1), the movable electrode 111A and the fixed electrode 111B do not become welded by pre-arc discharge. Thereby, even when the interrupting operation for switching the vacuum circuit breaker 211 from the closed state to the open state is executed and the movable electrode 111A and the fixed electrode 111B separate, the surfaces of the movable electrode 111A and the fixed electrode 111B do not become roughened, resulting in that the dielectric withstand capability of the vacuum circuit breaker 211 does not degrade.

Therefore, in the circuit breaker device 100 in this embodiment, sufficient dielectric withstand capability can be provided even when the vacuum circuit breaker 211 is used. Incidentally, in the execution of the second interrupting contact closing operation (ST2), pre-arc discharge occurs between the opposite-side arc contact 331 and the driving-side arc contact 451 that constitute the second interrupting contact 112, but unlike the case of the vacuum circuit breaker 211, degradation of the dielectric withstand capability does not occur. The influence of contact surface roughness on the dielectric withstand capability is smaller in the gas circuit breaker 251 than in the vacuum circuit breaker 211, and thus, there is no problem even when the pre-arc discharge occurs on the gas circuit breaker 251 side.

Further, in this embodiment, the start time point t112s of the second interrupting contact closing operation (ST2) is before the completion time point t111e of the first interrupting contact closing operation (ST1). Therefore, in the circuit breaker device 100 in this embodiment, the time for executing the circuit closing operation can be shortened.

### [F] Modified Example

Modified examples of this embodiment will be explained.

### [F-1] Modified Example 1-1

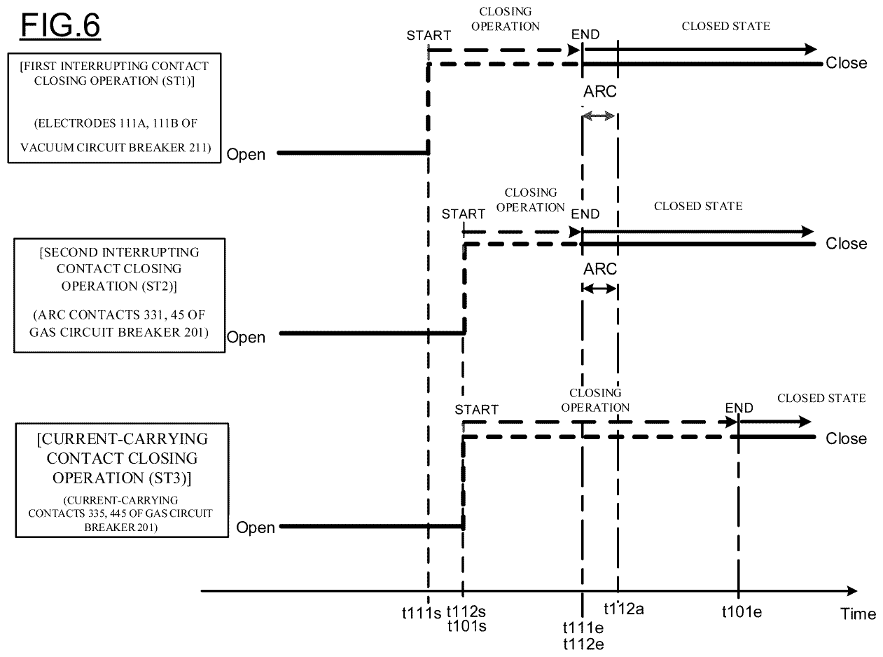

FIG. 6 is a view illustrating circuit closing operations (a first interrupting contact closing operation (ST1), a second interrupting contact closing operation (ST2), and a current-carrying contact closing operation (ST3)) executed in a modified example 1-1 of the first embodiment. In FIG. 6, similarly to FIG. 5, the horizontal axis represents time, and the vertical axis indicates a state of each contact (a current-carrying contact 101, a first interrupting contact 111, a second interrupting contact 112).

As illustrated in FIG. 6, in the circuit closing operation of this modified example, the completion time point t111e of the first interrupting contact closing operation (ST1) is the same as the completion time point t112e of the second interrupting contact closing operation (ST2). That is, in this modified example, the first interrupting contact 111 and the second interrupting contact 112 switch from the open state to the closed state simultaneously, and current flows through the interrupting electric circuit EC2 at the completion time point t111e of the first interrupting contact closing operation (ST1) and the completion time point t112e of the second interrupting contact closing operation (ST2).

For this reason, as illustrated in FIG. 6, at the completion time point t111e of the first interrupting contact closing operation (ST1), pre-arc discharge occurs between the movable electrode 111A and the fixed electrode 111B that constitute the first interrupting contact 111 in the vacuum circuit breaker 211, and an electrically connected state is established therebetween. Therefore, subsequently, when contact is made between the movable electrode 111A and the fixed electrode 111B, the movable electrode 111A and the fixed electrode 111B may enter a state of being welded by the pre-arc discharge.

However, as illustrated in FIG. 6, at the completion time point t112e of the second interrupting contact closing operation (ST2), which is the same time point as the completion time point t111e of the first interrupting contact closing operation (ST1), pre-arc discharge also occurs between the driving-side arc contact 451 and the opposite-side arc contact 331 that constitute the second interrupting contact 112 in the gas circuit breaker 251, and an electrically connected state is established therebetween.

Thus, in this modified example, pre-arc discharge occurs in the first interrupting contact 111 and the second interrupting contact 112 simultaneously. For this reason, the voltage (shared voltage) applied to the first interrupting contact 111 when current flows through the interrupting electric circuit EC2 in this modified example is lower than the case when current flows only through the first interrupting contact 111 in the interrupting electric circuit EC2. Similarly, the time from the occurrence to the extinction of the pre-arc discharge in the first interrupting contact 111 is shorter than the case when current flows only through the first interrupting contact 111 in the interrupting electric circuit EC2. As a result, the damage to the first interrupting contact 111 decreases compared to the case when current flows only through the first interrupting contact 111 in the interrupting electric circuit EC2.

Therefore, the dielectric withstand capability of the circuit breaker device 100 can be sufficiently maintained also in this modified example.

### [F-2] Modified Example 1-2

It is preferable that the closing speed at which the first interrupting contact 111 is switched from the open state to the closed state in the first interrupting contact closing operation (ST1) should be lower than the closing speed at which the second interrupting contact 112 is switched from the open state to the closed state in the second interrupting contact closing operation (ST2) and the closing speed at which the current-carrying contact 101 is switched from the open state to the closed state in the current-carrying contact closing operation (ST3).

When the closing speed of the first interrupting contact 111 is high, chattering (minute mechanical vibration) may occur in the vacuum circuit breaker 211 including the first interrupting contact 111. Therefore, when chattering occurs in the vacuum circuit breaker 211 including the first interrupting contact 111 during execution of the second interrupting contact closing operation (ST2), pre-arc discharge may occur in the first interrupting contact 111. However, the closing speed of the first interrupting contact 111 is lower than that of the second interrupting contact 112 and that of the current-carrying contact 101, and therefore, the occurrence of chattering in the vacuum circuit breaker 211 can be inhibited.

### Second Embodiment

### [A] Details of a Circuit Closing Operation

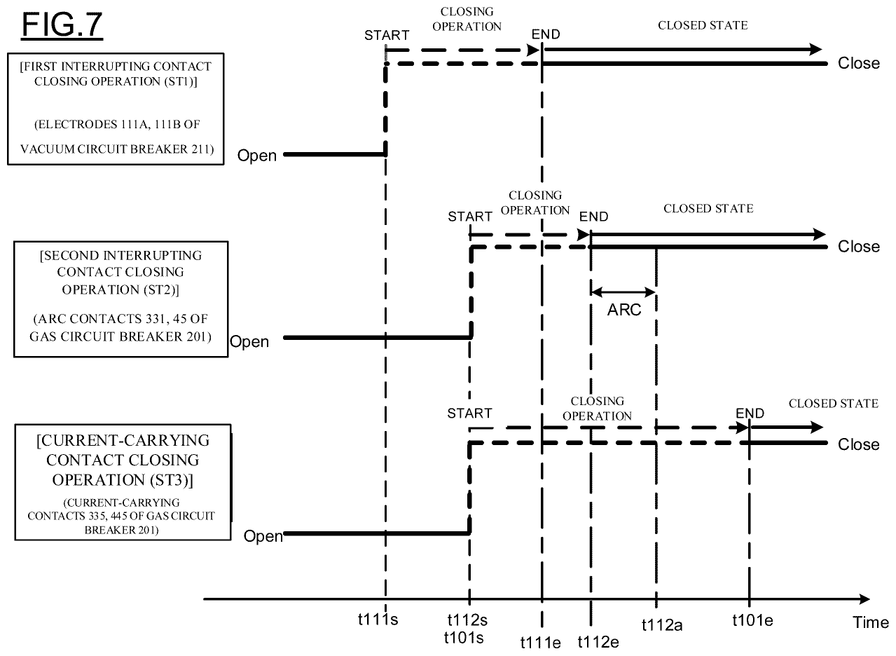

FIG. 7 is a view illustrating circuit closing operations (a first interrupting contact closing operation (ST1), a second interrupting contact closing operation (ST2), and a current-carrying contact closing operation (ST3)) executed in a second embodiment. In FIG. 7, similarly to FIG. 5, the horizontal axis represents time, and the vertical axis indicates a state of each contact (a current-carrying contact 101, a first interrupting contact 111, a second interrupting contact 112).

In this embodiment, as illustrated in FIG. 7, the circuit closing operation is partially different from that of the first embodiment (see FIG. 5). Except for this point and related matters, the circuit breaker device 100 in this embodiment is the same as that of the first embodiment. Therefore, explanation of overlapping matters will be omitted as appropriate.

As illustrated in FIG. 7, in the circuit closing operation of this embodiment, the start time point t112s of the second interrupting contact closing operation (ST2) and the start time point t101s of the current-carrying contact closing operation (ST3) are after the completion time point t111e of the first interrupting contact closing operation (ST1), which is different from the case of the first embodiment (see FIG. 5). That is, in this embodiment, after the first interrupting contact 111 switches from the open state to the closed state by the completion of the first interrupting contact closing operation (ST1), the second interrupting contact closing operation (ST2) and the current-carrying contact closing operation (ST3) are started, and the second interrupting contact 112 transitions from the open state to the closed state while the current-carrying contact 101 transitions from the open state to the closed state.

This embodiment includes a detection unit (not illustrated) such as a contact that outputs a signal when the first interrupting contact 111 switches from the open state to the closed state, and the control unit 800 causes the second interrupting contact 112 and the like to transition from the open state to the closed state in accordance with the signal output by the detection unit.

### [B] Summary

As described above, in this embodiment, since the second interrupting contact closing operation (ST2) is not started before the first interrupting contact closing operation (ST1) is completed, it is possible to reliably prevent current from flowing through the interrupting electric circuit EC2 during the first interrupting contact closing operation (ST1). As a result, in this embodiment, it is possible to reliably prevent the occurrence of pre-arc discharge between the movable electrode 111A and the fixed electrode 111B that constitute the first interrupting contact 111 in the vacuum circuit breaker 211, and thus the dielectric withstand capability of the vacuum circuit breaker 211 does not degrade.

Therefore, in the circuit breaker device 100 in this embodiment, the dielectric withstand capability can be provided even more sufficiently even when the vacuum circuit breaker 211 is used.

### Third Embodiment

### [A] Detailed Configuration of a Circuit Breaker Device 100

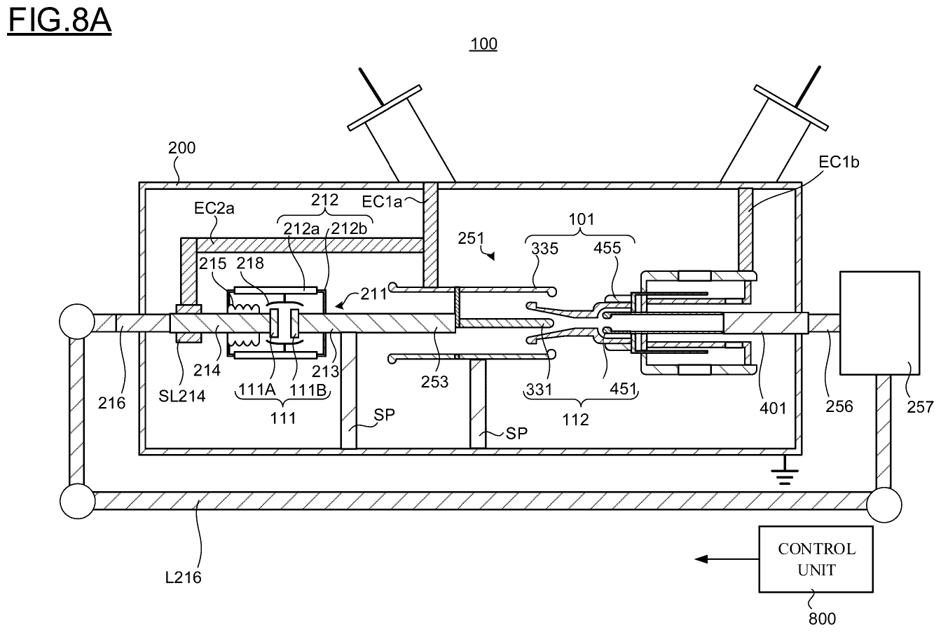

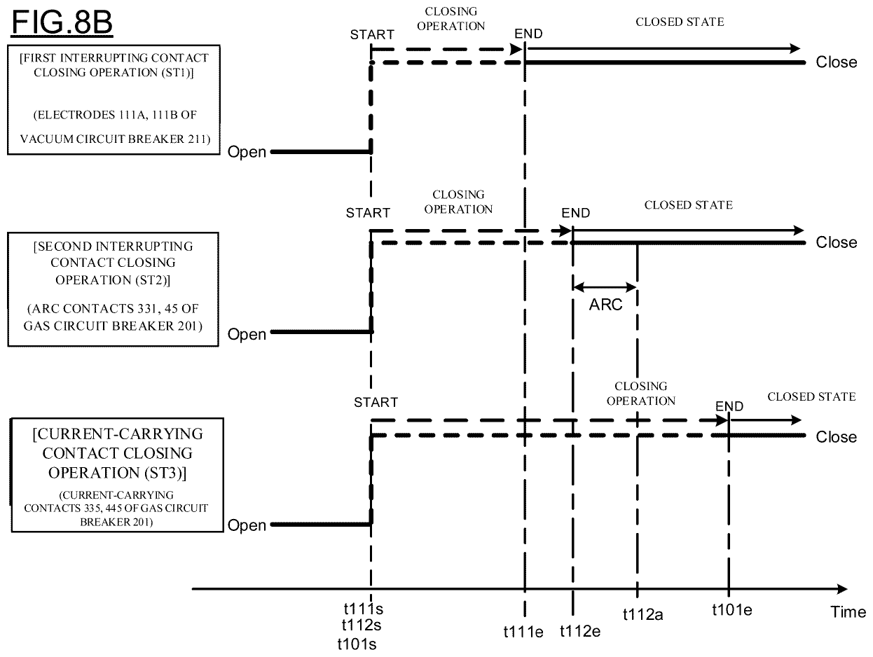

FIG. 8A is a cross-sectional view schematically illustrating a configuration of a circuit breaker device 100 according to a third embodiment. FIG. 8A illustrates the state where the circuit breaker device 100 is in the interrupted state, similarly to FIG. 2A.

As illustrated in FIG. 8A, the circuit breaker device 100 in this embodiment does not include the operating mechanism 217, which is different from the case of the first embodiment (see FIG. 2A). Except for this point and related matters, the circuit breaker device 100 in this embodiment is the same as that of the first embodiment. Therefore, explanation of overlapping matters will be omitted as appropriate.

As illustrated in FIG. 8A, in the circuit breaker device 100 in this embodiment, similarly to the case of the first embodiment (see FIG. 2A), the current-carrying contact 101 and the second interrupting contact 112 are configured to be operated by the operating mechanism 257.

However, in the circuit breaker device 100 in this embodiment, the operating mechanism 257 is further configured to operate the first interrupting contact 111. Here, the operating mechanism 257 is connected to the insulating rod 216 with an operation link L216 interposed therebetween, and is configured to switch the first interrupting contact 111 between the closed state and the open state by operating the insulating rod 216.

### [B] Details of the Circuit Closing Operation

FIG. 8B is a view illustrating circuit closing operations (a first interrupting contact closing operation (ST1), a second interrupting contact closing operation (ST2), and a current-carrying contact closing operation (ST3)) executed in the third embodiment. In FIG. 8B, similarly to FIG. 5, the horizontal axis represents time, and the vertical axis indicates a state of each contact (the current-carrying contact 101, the first interrupting contact 111, the second interrupting contact 112).

As illustrated in FIG. 8B, in the circuit closing operation in this embodiment, similarly to the case of the first embodiment (see FIG. 5), the completion time point t111e of the first interrupting contact closing operation (ST1) is at and before the completion time point t112e of the second interrupting contact closing operation (ST2). Then, the completion time point t112e of the second interrupting contact closing operation (ST2) is before the completion time point t101e of the current-carrying contact closing operation (ST3).

However, as illustrated in FIG. 8B, in the circuit closing operation in this embodiment, the start time point t111s of the first interrupting contact closing operation (ST1), the start time point t112s of the second interrupting contact closing operation (ST2), and the start time point t101s of the current-carrying contact closing operation (ST3) are the same, which is different from the case of the first embodiment (see FIG. 5). That is, in this embodiment, the first interrupting contact closing operation (ST1), the second interrupting contact closing operation (ST2), and the current-carrying contact closing operation (ST3) are started simultaneously.

### [C] Summary

As described above, the circuit breaker device 100 in this embodiment is configured so that the operating mechanism 257 operates the current-carrying contact 101, the first interrupting contact 111, and the second interrupting contact 112, and thereby the first interrupting contact closing operation (ST1), the second interrupting contact closing operation (ST2), and the current-carrying contact closing operation (ST3) are started simultaneously.

Therefore, in this embodiment, effects similar to those of the first embodiment can be obtained with a simplified device.

### [D] Modified Example

Incidentally, in the above-described embodiment, the case where the first interrupting contact closing operation (ST1), the second interrupting contact closing operation (ST2), and the current-carrying contact closing operation (ST3) are started simultaneously by the operation of the operating mechanism 257 has been explained, but the present invention is not limited to this. For example, the operating mechanism 257 may be configured so that the second interrupting contact closing operation (ST2) and the current-carrying contact closing operation (ST3) are started after the first interrupting contact closing operation (ST1) is started.

### Fourth Embodiment

### [A] Detailed Configuration of a Circuit Breaker Device 100

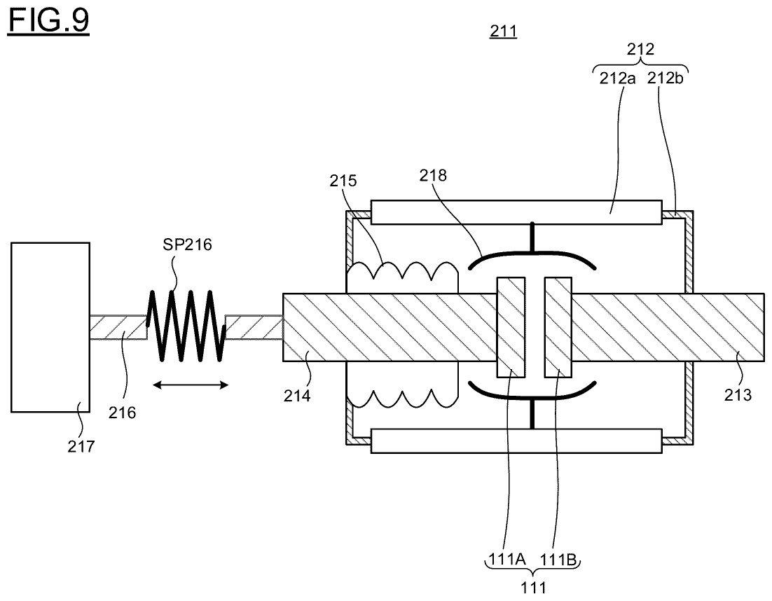

FIG. 9 is a cross-sectional view schematically illustrating a configuration of a vacuum circuit breaker 211 including a first interrupting contact 111 in a circuit breaker device according to a fourth embodiment.

In this embodiment, the vacuum circuit breaker 211 is partially different in the configuration from the first embodiment (see FIG. 2A), as illustrated in FIG. 9. Except for this point and related matters, the circuit breaker device 100 in this embodiment is the same as that of the first embodiment. Therefore, explanation of overlapping matters will be omitted as appropriate.

As illustrated in FIG. 9, in the vacuum circuit breaker 211 in this embodiment, a spring SP216 is installed on the vacuum circuit breaker movable current-carrying shaft 216. The vacuum circuit breaker 211 in this embodiment is configured so that when the first interrupting contact 111 is in the closed state, the movable electrode 111A is pressed against the fixed electrode 111B by the spring force of the spring SP216 to be brought into close contact therewith.

### [B] Summary

As described above, in this embodiment, after the first interrupting contact closing operation (ST1) is completed (the first interrupting contact 111 is in the closed state), in the vacuum circuit breaker 211, the movable electrode 111A enters a state of being in close contact with the fixed electrode 111B by the spring force of the spring SP216, thereby allowing the first interrupting contact 111 to reliably maintain the closed state. Therefore, in this embodiment, when the second interrupting contact closing operation (ST2) is executed after the first interrupting contact closing operation (ST1), chattering does not occur in the vacuum circuit breaker 211, thereby making it possible to prevent the pre-arc discharge from occurring between the movable electrode 111A and the fixed electrode 111B. As a result, in the circuit breaker device 100 in this embodiment, it is possible to effectively prevent degradation of the dielectric withstand capability of the vacuum circuit breaker 211.

Therefore, in the circuit breaker device 100 in this embodiment, the dielectric withstand capability can be provided even more sufficiently even when the vacuum circuit breaker 211 is used.

### Others

While several embodiments of the present invention have been described, these embodiments have been presented by way of example and are not intended to limit the scope of the invention. These embodiments can be implemented in various other forms, and various omissions, substitutions, and changes can be made without departing from the spirit of the invention. These embodiments and modifications thereof are included in the scope and spirit of the invention, and are also included in the invention described in the claims and their equivalents.

### EXPLANATION OF REFERENCE SIGNS

3: opposite-side unit, 4: driving-side unit, 100: circuit breaker device, 101: current-carrying contact, 111: first interrupting contact, 111A: movable electrode, 111B: fixed electrode, 112: second interrupting contact, 200: grounded tank, 202: insulating gas vessel, 211: vacuum circuit breaker, 212: vacuum vessel, 212a: insulating tube, 212b: flange, 213: vacuum circuit breaker fixed current-carrying shaft, 214: vacuum circuit breaker movable current-carrying shaft, 215: bellows, 216: insulating rod, 217: operating mechanism, 218: arc shield, 251: gas circuit breaker, 253: gas circuit breaker fixed current-carrying shaft, 256: insulating rod, 257: operating mechanism, 301: cooling cylinder, 302: support part, 303: opposite-side contact part, 321: support ring portion, 322: support protrusion, 331: opposite-side arc contact, 331a: end, 335: opposite-side current-carrying contact, 335a: end, 401: gas circuit breaker movable current-carrying shaft, 402: puffer cylinder, 403: puffer piston, 405: driving-side contact part, 406: cylinder support, 407: piston support, 411: movable current-carrying shaft solid portion, 412: movable current-carrying shaft hollow portion, 421: cylinder cylindrical tubular portion, 422: cylinder bottom plate portion, 451: driving-side arc contact, 451a: end, 455: driving-side current-carrying contact, 455a: end, 461: cylinder support cylindrical tubular portion, 462: cylinder support annular portion, 471: piston support cylindrical tubular portion, 472: piston support annular portion, 500: insulating nozzle, 510: nozzle large diameter portion, 520: nozzle small diameter portion, 530: nozzle inclined portion, 530a: end, 800: control unit, DS: driving side, EC: electric circuit, EC1: current-carrying electric circuit, EC2: interrupting electric circuit, H412: first ventilation hole, H422a: rod through hole, H422b: exhaust hole, H461: second ventilation hole, H471: third ventilation hole, L216: operation link, OS: opposite side, PR: puffer chamber, R: pre-arc discharge AR, S500: nozzle internal space, SL214: sliding part, SP: support, SP216: spring, ST1: first interrupting contact closing operation, ST2: second interrupting contact closing operation, ST3: current-carrying contact closing operation.

1. A circuit breaker device comprising:
a current-carrying contact;
a first interrupting contact connected in parallel with the current-carrying contact; and
a second interrupting contact connected in parallel with the current-carrying contact and also connected in series with the first interrupting contact, wherein
the first interrupting contact is constituted by a vacuum circuit breaker in which a closed state and an open state are switched inside a vacuum vessel,
the second interrupting contact and the current-carrying contact are constituted by a gas circuit breaker in which a closed state and an open state are switched inside an insulating gas vessel filled with an insulating gas, and
when executing a circuit closing operation for switching an electric circuit from an interrupted state to a current-carrying state, the circuit breaker device executes a first interrupting contact closing operation that switches the first interrupting contact from the open state to the closed state, a second interrupting contact closing operation that switches the second interrupting contact from the open state to the closed state, and a current-carrying contact closing operation that switches the current-carrying contact from the open state to the closed state,
a completion time point of the first interrupting contact closing operation is at or before a completion time point of the second interrupting contact closing operation, and the completion time point of the second interrupting contact closing operation is before a completion time point of the current-carrying contact closing operation, and
the circuit breaker device is configured so that when the first interrupting contact closing operation and the second interrupting contact closing operation are completed, current flows through the first interrupting contact and the second interrupting contact, and when the current-carrying contact closing operation is completed, a larger current flows through the current-carrying contact than through the first interrupting contact and the second interrupting contact.

2. The circuit breaker device according to claim 1, wherein
a start time point of the second interrupting contact closing operation is before the completion time point of the first interrupting contact closing operation.

3. The circuit breaker device according to claim 1, wherein
the completion time point of the first interrupting contact closing operation is the same as the completion time point of the second interrupting contact closing operation.

4. The circuit breaker device according to claim 1, wherein
a start time point of the second interrupting contact closing operation is after the completion time point of the first interrupting contact closing operation.

5. The circuit breaker device according to claim 1, wherein
a start time point of the first interrupting contact closing operation is the same as a start time point of the second interrupting contact closing operation.

6. The circuit breaker device according to claim 1, further comprising:
an operating mechanism that operates the current-carrying contact, the first interrupting contact, and the second interrupting contact.

7. The circuit breaker device according to claim 1, wherein
a closing speed at which the first interrupting contact is switched from the open state to the closed state in the first interrupting contact closing operation is lower than a closing speed at which the second interrupting contact is switched from the open state to the closed state in the second interrupting contact closing operation and a closing speed at which the current-carrying contact is switched from the open state to the closed state in the current-carrying contact closing operation.

8. The circuit breaker device according to claim 1, wherein the vacuum circuit breaker includes:
a movable electrode installed on a vacuum circuit breaker movable current-carrying shaft; and
a fixed electrode installed on a vacuum circuit breaker fixed current-carrying shaft aligned coaxially with the vacuum circuit breaker movable current-carrying shaft,
the vacuum circuit breaker is configured to enter the closed state by establishing an electrically connected state between the movable electrode and the fixed electrode, and
to enter the open state by establishing an electrically insulating state between the movable electrode and the fixed electrode,
a spring is installed on the vacuum circuit breaker movable current-carrying shaft, and
when the first interrupting contact is in the closed state, the movable electrode is pressed against the fixed electrode by a spring force of the spring to be brought into close contact therewith.

9. The circuit breaker device according to claim 1, wherein
the gas circuit breaker includes:
a gas circuit breaker movable current-carrying shaft on which a driving-side arc contact and a driving-side current-carrying contact are installed; and
a gas circuit breaker fixed current-carrying shaft that is aligned coaxially with the gas circuit breaker movable current-carrying shaft and on which an opposite-side arc contact and an opposite-side current-carrying contact are installed,
the current-carrying contact is configured to enter the closed state by establishing a connected state between the driving-side current-carrying contact and the opposite-side current-carrying contact, and
to enter the open state by establishing an insulating state between the driving-side current-carrying contact and the opposite-side current-carrying contact, and
the second interrupting contact is configured to enter the closed state by establishing a connected state between the driving-side arc contact and the opposite-side arc contact, and
to enter the open state by establishing an insulating state between the driving-side arc contact and the opposite-side arc contact.
